(19) United States
(12) Patent Application Publication
(10) Pub. No.: US 2012/0268564 A1
(43) Pub. Date: Oct. 25, 2012

(54) ELECTRONIC APPARATUS AND VIDEO DISPLAY METHOD

(75) Inventor: Norikazu NAGASAWA, Tokyo (JP)

(73) Assignee: KABUSHIKI KAISHA TOSHIBA, Tokyo (JP)

(21) Appl. No.: 13/332,221

(22) Filed: Dec. 20, 2011

(30) Foreign Application Priority Data
Apr. 19, 2011 (JP) 2011-093420

(51) Int. Cl. H04N 13/04

(52) U.S. Cl. 348/46; 348/E13.026

(57) ABSTRACT

An electronic apparatus includes a camera, a tracking module, a three-dimensional video adjusting module, a display, and an output direction controller. The tracking module is configured to recognize a position of a user based on a video picked up by the camera. The three-dimensional video adjusting module is output one of first video data and second video data by adjusting an input three-dimensional video signal, the first video data corresponding to a first stereoscopic video that appears stereoscopically when viewed from a predetermined position, the second video data corresponding to a second stereoscopic video that appears stereoscopically when viewed from the recognized position of the user.

### CROSS REFERENCE TO RELATED APPLICATIONS

This application is based upon and claims the benefit of priority from the prior Japanese Patent Application No. 2011-93420, filed on Apr. 19, 2011, the entire contents of which are incorporated herein by reference.

### FIELD

Embodiments described herein relate generally to an electronic apparatus and a video display method.

### BACKGROUND

In recent years, personal computers that are capable of stereoscopically displaying video have been rapidly spreading. In a personal computer of that type, parallax images viewed from different viewpoints are displayed on a display, and different parallax images are seen with the right eye and the left eye. Accordingly, a user can view a video stereoscopically.

In a case where a video is displayed auto-stereoscopically, that is, without glasses, the area in which the video can be stereoscopically viewed might become narrow. To counter this problem, there has been a known tracking function to recognize the position of a user and adjust a video so that the displayed video can be viewed stereoscopically from the user's position. However, there is a problem that when the tracking function is switched from on to off, the video optimized for the user's position while the tracking function is on, continues to be outputted.

### BRIEF DESCRIPTION OF THE DRAWINGS

FIG. 1 is a perspective view of an electronic apparatus 100.

FIG. 2 is a schematic block diagram showing a system configuration of the electronic apparatus 100.

FIG. 3 is a schematic block diagram showing the configuration of the video display system of the electronic apparatus 100 according to the first embodiment.

FIG. 4 is a flowchart showing an example of the processing operation of the video display system of FIG. 3.

FIG. 5 is a top view of the output direction controller 22 and the display 21.

FIG. 6 is a schematic block diagram showing the configuration of the video display system of the electronic apparatus 100 according to the second embodiment.

FIG. 7 is a flowchart showing an example of the processing operation of the video display system of FIG. 6.

### DETAILED DESCRIPTION

In general, according to one embodiment, an electronic apparatus includes a camera, a tracking module, a three-dimensional video adjusting module, a display, and an output direction controller.

The tracking module is configured to recognize a position of a user based on a video picked up by the camera. The three-dimensional video adjusting module is output one of first video data and second video data by adjusting an input three-dimensional video signal, the first video data corresponding to a first stereoscopic video that appears stereoscopically when viewed from a predetermined position, the second video data corresponding to a second stereoscopic video that appears stereoscopically when viewed from the recognized position of the user. The display is configured to display one of the first stereoscopic video corresponding to the first video data outputted from the three-dimensional video adjusting module and the second stereoscopic video corresponding to the second video data outputted from the three-dimensional video adjusting module on a display. The output direction controller is configured to control an output direction from the display in such a manner that the video displayed on the display appears stereoscopically when viewed from one of the predetermined position and the position of the user.

Embodiments will now be explained with reference to the accompanying drawings.

### First Embodiment

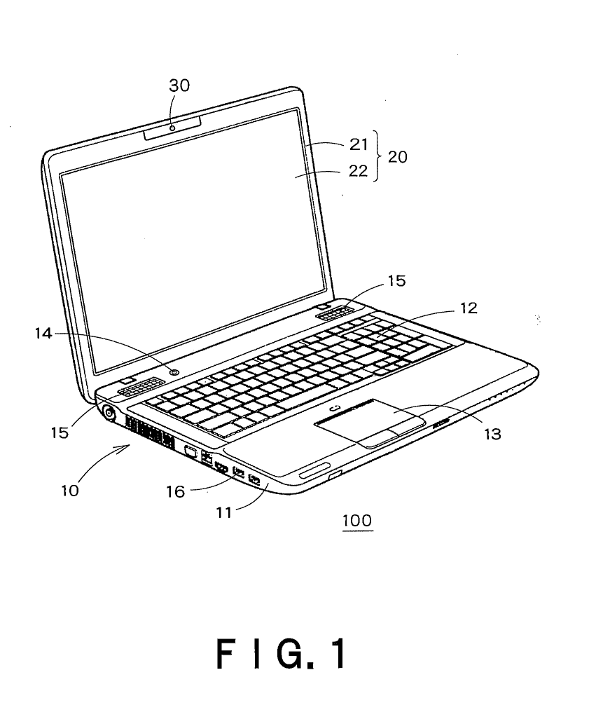

FIG. 1 is a perspective view of an electronic apparatus 100. FIG. 1 shows a personal computer which is an example of the electronic apparatus 100. The electronic apparatus 100 has a body 10, a display module 20 and a camera 30.

The body 10 has a case 11 of thin boxed-shape. Arranged on the case 11 are a keyboard 12, a touch pad 13 and a power button 14 which are for receiving the user's operation, and speakers 15 and so on. Furthermore, arranged in the case 11 are a CPU (Central Processing Unit), a main memory and an HDD and so on, which will be described below.

The keyboard 12 is an input device for generating signals indicative of operation characteristics such as character-entering and icon-selection. The touch pad 13 is a pointing device for generating signals indicative of operation characteristics such as screen-transition, cursor-motion and icon-selection. The power button 14 is a switch for on/off-controlling the power of the electronic apparatus 100. Additionally, various indicators indicative of whether or not the power is on, the battery is charged and so on, and buttons for activating predetermined functions may be arranged on the top face of the case 11.

The display module 20 has a display 21, an output direction controller 22 facing the display 21, and various circuits (not shown) for controlling the display 21 and the output direction controller 22, and is rotatably attached on the body 10 via a hinge.

The display 21 can display multiple parallax images simultaneously viewed from different viewpoints in order to display video stereoscopically. The output direction controller 22 controls the output direction of the video displayed on the display 21. The output direction controller 22 is, for example, a liquid crystal filter, and can control the output direction by deflecting the liquid crystal materials.

The camera 30 is arranged, for example, above the display module 20. In order to recognize the position of the user, the camera picks up a predetermined area in front of the display 21. Furthermore, for the purpose of improving the security, indicators (not shown), which indicates the operation status of the camera 30, can be provided near the camera 30.

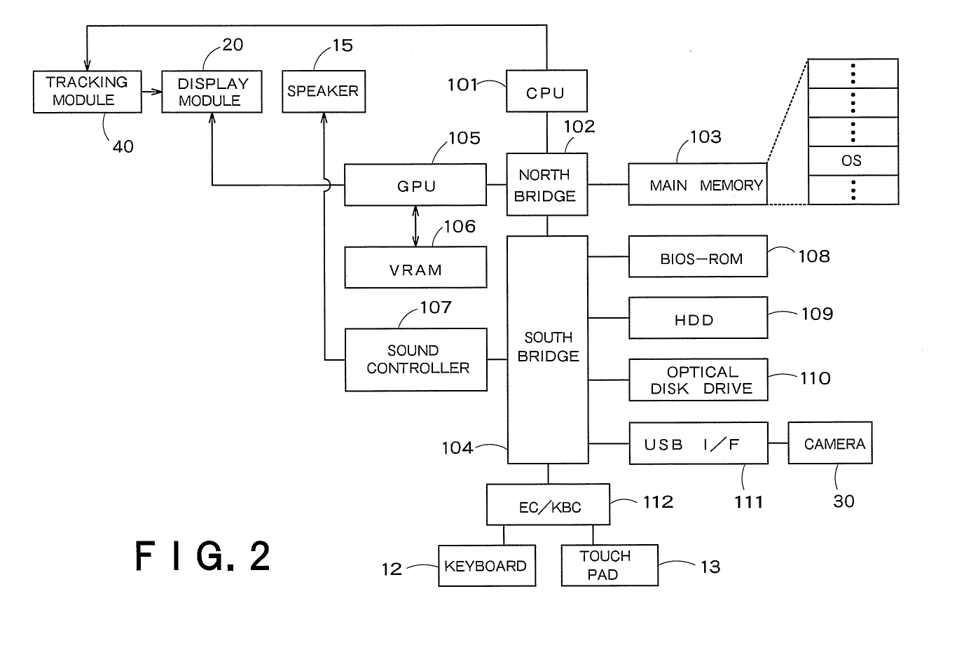

FIG. 2 is a schematic block diagram showing a system configuration of the electronic apparatus 100. The electronic apparatus 100 has the CPU 101, a north bridge 102, the main memory 103, a south bridge 104, a GPU (Graphic Processing Unit) 105, a tracking module 40, a display module 20, a VRAM (Video memory) 106, a sound controller 107, a BIOS-ROM (Basic Input Output System Read Only Memory) 108, the HDD 109, an optical disk drive 110, an USB (Universal Serial Bus) interface 111, and an EC/KBC (Embedded Controller/Keyboard Controller) 112.

The CPU 101 is a processor for controlling operations of the electronic apparatus 100, and executes OS and various application programs loaded from the HDD 109 to the main memory 103. Furthermore, the CPU 101 executes system BIOS loaded from the BIOS-ROM 108 to the main memory 103. The system BIOS is a program for hardware control.

The north bridge 102 is a bridge device for connecting the CPU 101 with the south bridge 104. The north bridge 102 includes a memory controller for controlling the main memory 103. Furthermore, the north bridge 102 communicates with the GPU 105 through the serial bus. The main memory 103 is a working memory for extracting the OS and the various applications stored in the HDD 109 and the system BIOS stored in the BIOS-ROM 108.

The south bridge 104 controls the BIOS-ROM 108, the HDD 109 and the optical disk drive 110. Furthermore, the south bridge 104 communicates with the sound controller 107. Additionally, the south bridge 104 has a USB controller and connected to the camera 30 through the USB interface 111. The video picked up by the camera 30 is provided to the tracking module 40. Furthermore, an external HDD, a USB memory and so on, in which video signals and audio signals are stored, can be connected to the USB interface 111 through the USB terminal 16 on the body 10.

The GPU 105 sends the display data stored in the VRAM 106 by the OS to the display module 20. The sound controller 107 sends sound data to be reproduced to the speakers 15, and output it from the speakers 15. The EC/KBC 112 is a one-chip microcomputer having an embedded controller for controlling the power and a keyboard controller for controlling the keyboard 12 and the touch pad and so on. The EC/KBC 112 on/off-controls the electronic apparatus 100 in accordance with the operation of the power button 14 from the user.

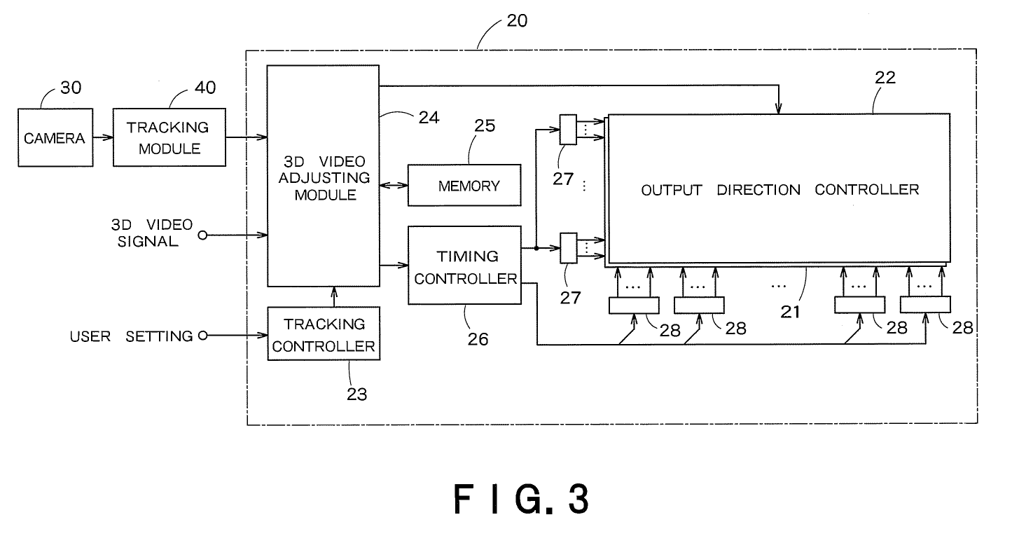

FIG. 3 is a schematic block diagram showing the configuration of the video display system of the electronic apparatus 100 according to the first embodiment. The video display system includes the camera 30, the tracking module 40, a tracking controller 23, a three-dimensional video adjusting module 24, a memory 25, a timing controller 26, a gate driver 27, a source driver 28, the display 21, and the output direction controller 22.

The camera 30 picks up a predetermined area in front of the display 21 to recognize the position of a user, and supplies the picked-up video to the tracking module 40.

The tracking module 40 recognizes the position of the user by tracking the face, more specifically, the eyes of the user from the video picked up by the camera 30. The tracking module 40 supplies the recognized position of the user to the three-dimensional video adjusting module 24. The tracking module 40 is implemented by an integrated circuit (IC), for example.

The tracking controller 23 receives an instruction from the user via the keyboard 12 or the touchpad 13. In accordance with the instruction, the tracking controller 23 determines whether or not to perform an operation depending on the position of the user, that is, on/off-controls a tracking function.

A three-dimensional video signal is input from the GPU 105 to the three-dimensional video adjusting module 24. The three-dimensional video signal is generated based on a two-dimensional video signal, which is stored in an optical disk inserted into the HDD 109 or the optical disk drive 110, and depth information. The three-dimensional video signal contains parallax images, or at least two parallax images for the right eye and the left eye. The depth information is information indicative of how far each pixel is to appear in front of or behind the display 21. The depth information may be added in advance to each video signal. If the depth information is not added in advance, the depth information may be generated based on the characteristics of the video signal.

The three-dimensional video adjusting module 24 adjusts the three-dimensional video signal, to generate front video data (first video data) for displaying a video (first stereoscopic video) that appears stereoscopically when viewed from a location facing the center of the display 21 (the location being hereinafter referred to as the “front area”). The front video data is then stored into the memory 25. When the tracking function is off, the three-dimensional video adjusting module 24 reads the front video data stored in the memory 25, and supplies the front video data to the timing controller 26.

When the tracking function is on, the three-dimensional video adjusting module 24 adjusts the three-dimensional video signal, to generate tracking video data (second video data) corresponding to a video (second stereoscopic video) that appears stereoscopically when viewed from the position of the user. The tracking video data is then supplied to the timing controller 26.

The three-dimensional video adjusting module 24 and the tracking controller 23 are implemented by an IC, for example.

The output direction controller 22 controls the output direction of the image displayed on the display 21. More specifically, when the tracking function is off, the output direction controller 22 controls the output direction so that the video appears stereoscopically when viewed from the front area. When the tracking function is on, under the control of the three-dimensional video adjusting module 24, the output direction controller 22 controls the output direction so that the video appears stereoscopically when viewed from the position of the user. In this manner, the parallax image for the right eye is directed toward the right eye of the user, and the left-eye parallax image is directed toward the left eye of the user, so that the user can view the video stereoscopically without glasses.

The display 21 is a liquid crystal panel of 15.6 inches in the length of each diagonal line, for example. The display 21 is formed by two facing glass substrates between which liquid crystal materials are inserted. The display 21 has scanning lines (768 scanning lines, for example), signal lines (1366*3 signal lines, for example), and liquid crystal pixels formed at the respective intersections of the scanning lines and the signal lines. A backlight device (not shown) emitting light to the display 21 is also provided on the back side of the display 21.

The timing controller 26 supplies the front video data or the tracking video data supplied from the three-dimensional video adjusting module 24 to the source driver 28, and controls the operation timings of the gate driver 27 and the source driver 28. The gate driver 27 sequentially selects a scanning line by turns. The source driver 28 supplies the video data to a signal line. The video data is then supplied to the liquid crystal pixel connected to the scanning line selected by the gate driver 27, and the orientation of the liquid crystal material in the liquid crystal pixel varies according to the video data. Among the light emitted from the backlight device, the light having the intensity corresponding to the orientation of the liquid crystal material passes through the liquid crystal material, and the video corresponding to the video data is displayed on the display 21.

The tracking controller 23, the three-dimensional video adjusting module 24, the memory 25, the timing controller 26, the gate driver 27, and the source driver 28 are provided on the back face of the backlight device, and, together with the display 21 and the output direction controller 22, constitute the display module 20. Other than that, the display module 20 may include an EDID-ROM that stores information compliant with the VESA (Video Electronics Standards Association) standards and is connected with an inter-integrated circuit (I²C), or the like.

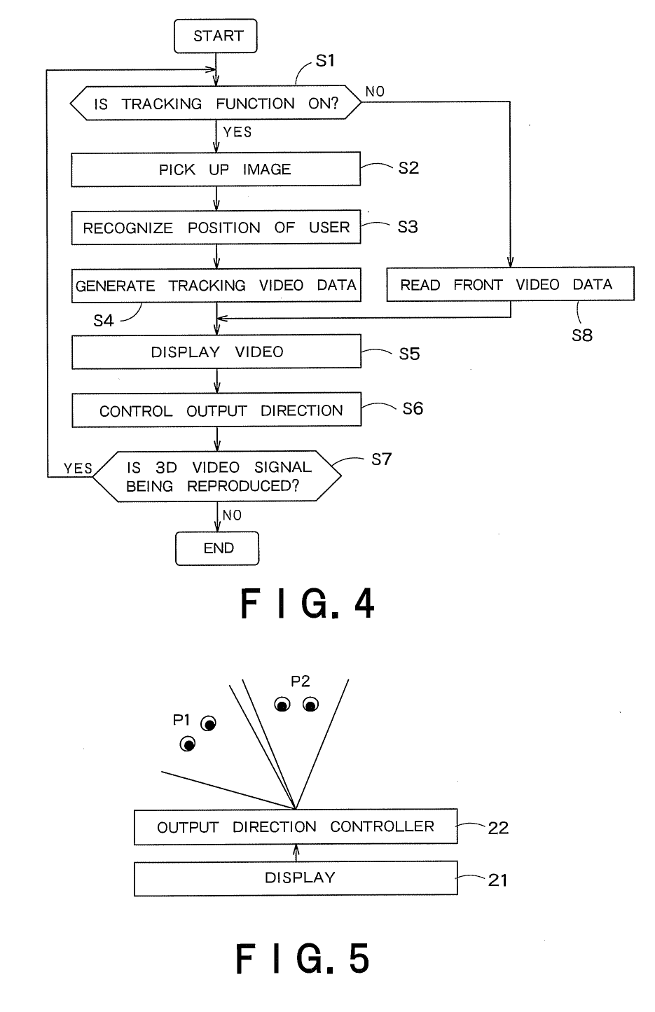

FIG. 4 is a flowchart showing an example of the processing operation of the video display system of FIG. 3. It should be noted that, during reproduction of a three-dimensional video, the three-dimensional video adjusting module 24 sequentially adjusts input three-dimensional video signals to generate the front video data, and stores the front video data into the memory 25 in advance.

When the tracking function is set at on by a user during reproduction of a three-dimensional video signal (YES in step S1), the camera 30 picks up a predetermined area in front of the display 21, and supplies the picked up video to the tracking module 40 (step S2). Based on the video, the tracking module 40 recognizes the position of the user (step S3). The three-dimensional video adjusting module 24 then adjusts an input three-dimensional video signal to generate the tracking video data so that the video to be displayed on the display 21 appears stereoscopically when viewed from the recognized position of the user. The three-dimensional video adjusting module 24 then supplies the tracking video data to the timing controller 26 (step S4). The video corresponding to the tracking video data is then displayed on the display 21 (step S5).

The three-dimensional video adjusting module 24 further controls the output direction controller 22 so that the displayed video appears stereoscopically when viewed from the position of the user (step S6).

FIG. 5 is a top view of the output direction controller 22 and the display 21. A video to be displayed on the display 21 is directed in a direction almost perpendicular to the display 21. Therefore, if the user is in a position P1 at the right side of the display 21 as seen from the user, the output direction controller 22 controls the output direction of the video toward the position P1, so that the video appears stereoscopically when the display 21 is viewed from the vicinity of the position P1.

If the video corresponding to the tracking video data is displayed on the entire screen of the display 21, the three-dimensional video adjusting module 24 controls the output direction controller 22 so that the output direction of the entire video to be displayed on the display 21 is controlled. However, if the video corresponding to the tracking video data is to be displayed on only a part of the display 21, the three-dimensional video adjusting module 24 may control only the output direction of the video.

The video display system repeats the above processing as long as the three-dimensional video signal reproduction is continued (YES in step S7) and the tracking function remains on. It should be noted that the sequence of the steps S1 through S7 may be changed as appropriate.

On the other hand, if the tracking function is set at off or is switched off by the user (NO in step S1), the three-dimensional video adjusting module 24 reads the front video data stored in the memory 25, and supplies the front video data to the timing controller 26 (step S8). The video corresponding to the front video data is then displayed on the display 21 (step S5). The three-dimensional video adjusting module 24 further controls the output direction controller 22 so that the displayed video appears stereoscopically when viewed from a position including the front area (step S6).

For example, it is assumed that the user is in the position P1 shown in FIG. 5, and sets the tracking function at on. In such a case, the output direction controller 22 outputs a video in the direction of the position P1, as described above. When the user switches off the tracking function at certain time, the output direction controller 22 switches the output direction to such a direction that the video appears stereoscopically when viewed from the position P2 of the front area, through the processing of step S8 of FIG. 4. It should be understood that the output direction controller 22 does not fix the output direction to the direction of the position P1 in which the user was present.

If the output direction is fixed, the output direction of the video after the tracking function is switched off depends on the position in which the user was present prior to the switching, and therefore, the output direction of the video varies every time. As a result, when the user moves after switching off the tracking function, it might become unclear from which direction the video can be viewed stereoscopically. In this embodiment, on the other hand, once the tracking function is switched off, a control operation is performed so that the video always appears stereoscopically when viewed from the front area, regardless of the position of the user at the time. Accordingly, the user can view the video stereoscopically by moving into the front area.

When the video data to be supplied from the three-dimensional video adjusting module 24 to the timing controller 26 is switched from the front video data to the tracking video data, or from the tracking video data to the front video data, it is preferable that the video data is switched not at arbitrary time but during the vertical blanking period of the video data prior to the switching. By such a manner, the displayed video can be certainly switched, starting from the first line of the video. Accordingly, a video disturbed by the video switching during the scanning is not displayed, and generation of noise can be restrained.

As described above, in the first embodiment, when the tracking function is off, a video is displayed so as to appear stereoscopically when viewed from the front area, regardless of the position of the user. Accordingly, a stereoscopical video can be properly displayed independent of whether or not the tracking function is on.

### Second Embodiment

Even after a user sets the tracking function at on, the tracking module 40 might not be able to recognize the position of the user. Therefore, according to a second embodiment described below, the tracking function is switched off when the position of the user cannot be recognized.

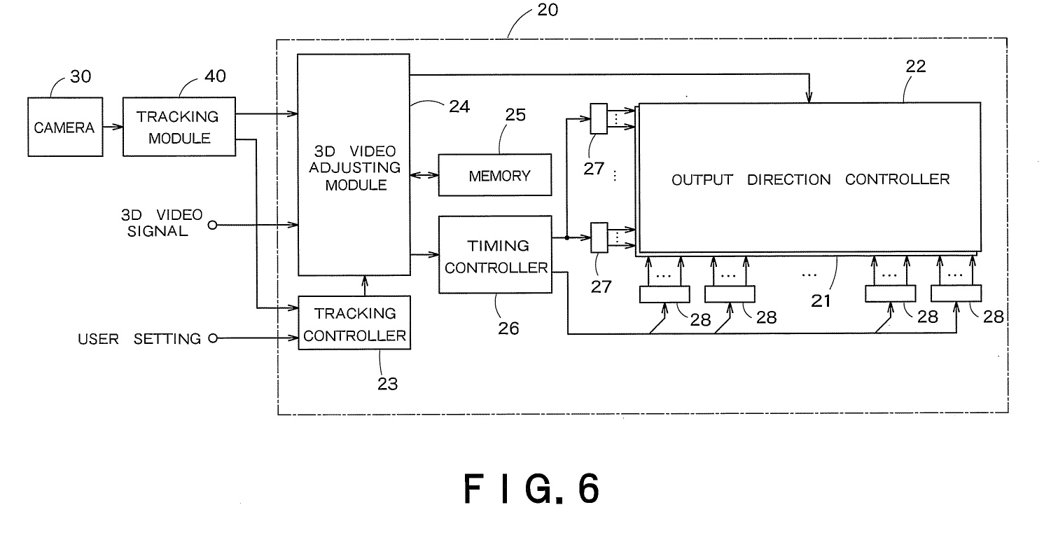

FIG. 6 is a schematic block diagram showing the configuration of the video display system of the electronic apparatus 100 according to the second embodiment. In FIG. 6, the same components as those of FIG. 3 are denoted by the same reference numerals as those used in FIG. 3, and the different aspects from the first embodiment are mainly described below.

In the video display system of FIG. 6, the tracking module 40 supplies to the tracking controller 23 with the information indicative of whether or not the position of a user has been recognized. In a case where the user has set the tracking function at on, and the tracking module 40 has recognized the position of the user, the tracking controller 23 switches on the tracking function. In other words, even if the user has set the tracking function at on, the tracking controller 23 switches off the tracking function when the tracking module 40 fails to recognize the position of the user.

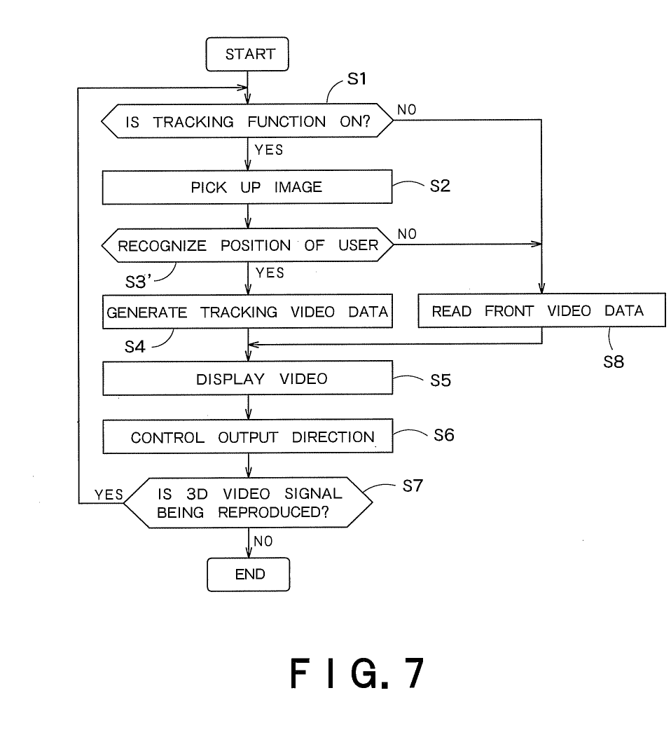

FIG. 7 is a flowchart showing an example of the processing operation of the video display system of FIG. 6. when the tracking function is set at on by a user (YES in step S1), the camera 30 picks up a predetermined area in front of the display 21, and supplies the picked up video to the tracking module 40 (step S2).

If the tracking module 40 can recognize the position of the user based on the supplied video (YES in step S3′), the video display system carries out the processing of step S4 and the later steps as in the first embodiment, to display the video corresponding to the tracking video data.

On the other hand, if the tracking module 40 cannot recognize the position of the user (NO in step S3′), the tracking controller 23 switches off the tracking function, and the video corresponding to the front video data is displayed (step S8 and the later steps). For example, if the user who has been viewing the video after setting the tracking function at on moves out of the image pickup area of the camera 30, a video that appears stereoscopically when viewed from the front area is displayed.

As described above, in the second embodiment, the tracking function is switched off when the position of the user cannot be recognized. Accordingly, even when the position of the user cannot be recognized, a stereoscopical video can be properly displayed. For example, in a case where the electronic apparatus 100 is exhibited on a storefront, the video displayed on the display 21 is not always viewed by someone, and is sometimes viewed by more than one person. In such cases, the position of a user might not be recognized, but a video can be always displayed stereoscopically when viewed from the front area. Also, when the camera 30 has some trouble, a video can be effectively displayed in a stereoscopic manner when viewed from the front area.

At least a part of the video display system explained in the above embodiments can be formed of hardware or software. When the video display system is partially formed of the software, it is possible to store a program implementing at least a partial function of the video display system in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the video display system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An electronic apparatus comprising:
a camera;
a tracker configured to recognize a position of a user based on a video captured by the camera;
a three-dimensional video adjuster configured to output first video data or second video data by adjusting an input three-dimensional video signal, the first video data corresponding to a first stereoscopic video that appears stereoscopically when viewed from a first position, and the second video data corresponding to a second stereoscopic video that appears stereoscopically when viewed from the position of the user;
a display configured to display the first stereoscopic video or the second stereoscopic video; and
an output direction controller configured to control an output direction from the display such that the displayed video appears stereoscopically when viewed from the first position or the position of the user.

2. The apparatus of claim 1, further comprising a memory configured to store the first video data generated by the three-dimensional video adjuster.

3. The apparatus of claim 1, wherein the three-dimensional video adjuster is configured to switch the video data to be outputted during a vertical blanking period.

4. The apparatus of claim 1 further comprising a tracking controller configured to receive an instruction from the user, and control the three-dimensional video adjuster and the output direction controller, in accordance with the received instruction, depending on the position of the user.

5. The apparatus of claim 4, wherein the tracking controller is configured to control the three-dimensional video adjuster and the output direction controller so as not to perform processing depending on the position of the user when the position of the user cannot be recognized.

6. The apparatus of claim 1, wherein the first position includes a position facing a center of the display.

7. The apparatus of claim 1, wherein the tracking module is configured to recognize the position of the user by tracking a face of the user from the video captured by the camera.

8. The apparatus of claim 1, wherein the output direction controller is configured to control the output direction of the first stereoscopic video or the second stereoscopic video or a combination thereof, among video displayed on the display.

9. A video display method comprising:
recognizing a position of a user based on a video captured by a camera;
generating and outputting first video data or second video data by adjusting an input three-dimensional video signal, the first video data corresponding to a first stereoscopic video that appears stereoscopically when viewed from a first position, and the second video data corresponding to a second stereoscopic video that appears stereoscopically when viewed from the position of the user;
displaying the first stereoscopic video or the second stereoscopic video on a display; and
controlling an output direction from the display such that the displayed video appears stereoscopically when viewed from the first position or the position of the user.

10. The method of claim 9, further comprising generating and storing the first video data.

11. The method of claim 9, wherein the video data to be outputted is switched during a vertical blanking period.

12. The method of claim 9, wherein whether to perform processing depending on the position of the user is controlled in accordance with an instruction.

13. The method of claim 12, wherein the processing depending on the position of the user is not performed when the position of the user cannot be recognized.

14. The method of claim 9, wherein the first position includes a position facing a center of the display.

15. The method of claim 9, wherein the position of the user is recognized by tracking a face of the user from the video captured by the camera.

16. The method of claim 9, wherein the output direction of the first stereoscopic video or the second stereoscopic video or a combination thereof among video displayed on the display is controlled.
